(19) United States
(12) Patent Application Publication
(10) Pub. No.: US 2021/0232870 A1
(43) Pub. Date: Jul. 29, 2021

(54) PU Classification Device, PU Classification Method, and Recording Medium

(71) Applicant: Aipore Inc., Tokyo (JP)

(72) Inventors: Takashi Washio, Suita-shi, Osaka (JP); Masateru Taniguchi, Suita-shi, Osaka (JP); Takahito Ohshiro, Suita-shi, Osaka (JP); Takeshi Yoshida, Suita-shi, Osaka (JP)

(21) Appl. No.: 17/050,903

(22) PCT Filed: Mar. 28, 2019
(86) PCT No.: PCT/JP2019/013650

§ 371 Date: Oct. 27, 2020

(30) Foreign Application Priority Data
Apr. 27, 2018 (JP) 2018-087641

(51) Int. Cl. G06K 9/62; G06N 7/00

(52) U.S. Cl. CPC G06K 9/6277; G06K 9/6259; G06N 7/005

(57) ABSTRACT

A PU classification device includes a classifier that performs maximum likelihood classification of an instance to be classified as a positive instance or a negative instance based on a magnitude relationship between a first probability that the instance is sampled from a population distribution for learning as the positive instance and a second probability that the instance is sampled from the population distribution for learning, when the instance to be classified is given, and a processor that learns the classifier by estimating a distribution function of the first probability from a set of positive instances sampled from the population distribution for learning and by estimating a distribution function of the second probability from a set of instances that are sampled from the population distribution for learning and are unknown whether they are positive or negative, wherein an instance to be classified is classified as the positive instance or the negative instance by using the classifier learned by the processor.

### CROSS-REFERENCE TO RELATED APPLICATIONS

This application is the national phase of PCT International Application No. PCT/JP2019/013650 which has an International filing date of Mar. 28, 2019 and designated the United States of America.

### FIELD

The present application relates to a PU classification device, a PU classification method, and a recording medium.

### BACKGROUND

Conventionally, a PU classification method (Classification of Positive and Unlabeled Examples) has been proposed in which a classifier is learned that separates positive instances and negative instances included in unknown instances from a set of positive instances and a set of instances not known as being positive or being negative.

For example, following documents disclose the conventional PU classification method.
[Non-Patent Document 1] Elkan, C. and Noto, K. “Learning classifiers from only positive and unlabeled data,” in Proc. KDD08: the 14th ACM SIGKDD Int. Conf. on Knowledge Discovery and Data Mining, pp. 213-220 (2008)
[Non-Patent Document 2] Ward, G., Hastie, T., Barry, S., Elith, J., and Leathwick, J. R. “Presence-only data and the em algorithm,” Biometrics, Vol. 65, No. 2, pp. 554-563 (2009)

However, the conventional PU classification method, which uses the Bayesian estimation principle, is a classification method based on the assumption that a set of instances which are not known as being positive or being negative and are to be actually classified and a set of unknown instances having been used for learning are sampled from statistically the same probability distribution.

For this reason, for example, in a case where like a target set of instances for calibration of a sensor and a set of instances to be actually measured, the positive-to-negative ratio is different between the learning instances and the actual target instances and further, it is impossible to obtain the clue for knowing the difference in advance, the conventional PU classification method cannot achieve sufficient classification accuracy.

### SUMMARY

The present application is made in view of such circumstances, and an object thereof is to provide a PU classification device, a PU classification method and a recording medium capable of achieving sufficient classification accuracy even when the positive-to-negative ratio is different between the learning instances and the actual target instances and it is impossible to obtain the clue for knowing the difference in advance.

A PU classification device according to one aspect of the present application is provided with a classifier that performs maximum likelihood classification of an instance to be classified as a positive instance or a negative instance based on a magnitude relationship between a first probability that the instance is sampled from a population distribution for learning as the positive instance and a second probability that the instance is sampled from the population distribution for learning, when the instance to be classified is given; and a processor that learns the classifier by estimating a distribution function of the first probability from a set of positive instances sampled from the population distribution for learning and by estimating a distribution function of the second probability from a set of instances that are sampled from the population distribution for learning and are unknown whether they are positive or negative, wherein an instance to be classified is classified as the positive instance or the negative instance by using the classifier learned by the processor.

A PU classification method according to one aspect of the present application is provided with learning a classifier that performs maximum likelihood classification of an instance to be classified as a positive instance or a negative instance based on a magnitude relationship between a first probability that the instance is sampled from a population distribution for learning as the positive instance and a second probability that the instance is sampled from the population distribution for learning, when the instance to be classified is given, by estimating a distribution function of the first probability from a set of positive instances sampled from the population distribution for learning and by estimating a distribution function of the second probability from a set of instances that are sampled from the population distribution for learning and are unknown whether they are positive or negative, and classifying an instance to be classified as the positive instance or the negative instance by using the learned classifier.

A recording medium according to one aspect of the present application stores a PU classification program for causing a computer to learn a classifier that performs maximum likelihood classification of an instance to be classified as a positive instance or a negative instance based on a magnitude relationship between a first probability that the instance is sampled from a population distribution for learning as the positive instance and a second probability that the instance is sampled from the population distribution for learning, when the instance to be classified is given, by estimating a distribution function of the first probability from a set of positive instances sampled from the population distribution for learning and by estimating a distribution function of the second probability from a set of instances that are sampled from the population distribution for learning and are unknown whether they are positive or negative, and causing the computer to classify an instance to be classified as the positive instance or the negative instance by using the learned classifier.

According to the present application, sufficient classification accuracy can be achieved even when the positive-to-negative ratio is different between the learning instances and the actual target instances and it is impossible to obtain the clue for knowing the difference in advance.

The above and further objects and features of the invention will more fully be apparent from the following detailed description with accompanying drawings.

### BRIEF DESCRIPTION OF DRAWINGS

FIG. 1 is a block diagram showing the hardware configuration of a classification device according to the present embodiment;

FIG. 2 is an explanatory view explaining the functional components of the classification device according to a first embodiment;

FIGS. 3A and 3B are explanatory views each explaining the schematic structure of a measurement system in a detection system;

FIGS. 4A and 4B are waveform charts each showing an example of a measurement signal obtained by the measurement system;

FIG. 5 is a flowchart explaining the procedure of the processing executed by a classification device;

FIG. 6 is a table showing the performance evaluation of the classification device according to the first embodiment; and

FIG. 7 is a table showing the performance evaluation of the classification device according to a second embodiment.

### DESCRIPTION OF EMBODIMENTS

Hereinafter, the present application will be concretely described based on the drawings showing embodiments thereof.

### First Embodiment

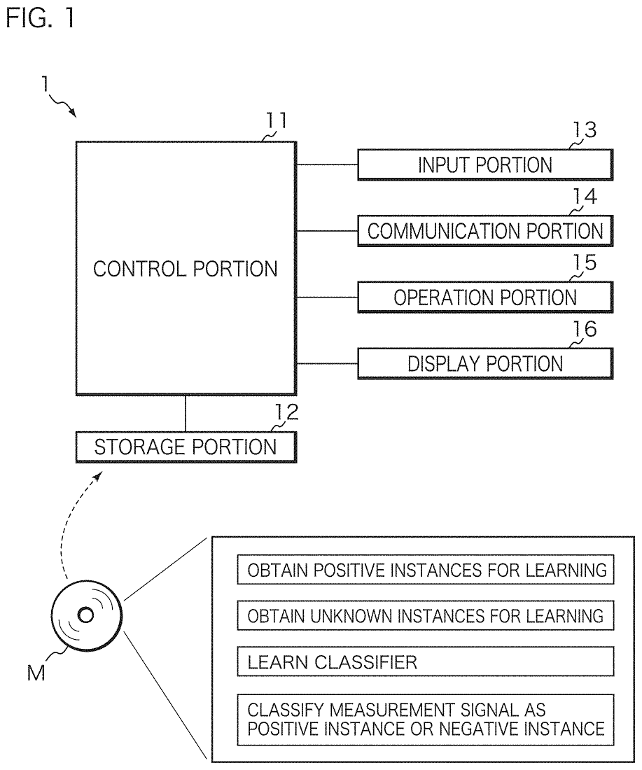

FIG. 1 is a block diagram showing the hardware configuration of a classification device 1 according to the present embodiment. The classification device 1 according to the present embodiment is an information processing device such as a personal computer or a server device, and is provided with a control portion 11, a storage portion 12, an input portion 13, a communication portion 14, an operation portion 15 and a display portion 16. The classification device 1 classifies an inputted instance to be classified, as a positive instance or a negative instance.

The control portion 11 is provided with a CPU (Central Processing Unit), a ROM (Read Only Memory), a RAM (Random Access Memory) and the like. The ROM that the control portion 11 is provided with stores a control program for controlling the operations of the above-mentioned hardware portions, and the like. The CPU in the control portion 11 executes the control program stored in the ROM and various programs stored in the storage portion 12 described later to control the operations of the above-mentioned hardware portions, thereby causing the entire device to function as the PU classification device of the present application. The RAM that the control portion 11 is provided with stores data temporarily used during the execution of various programs.

The control portion 11 is not limited to the above-described structure and is one or more than one processing circuit or arithmetic circuit including a single core CPU, a multi core CPU, a GPU (Graphic Processing Unit), a microcomputer, a volatile or nonvolatile memory and the like. Moreover, the control portion 11 may be provided with the functions as a clock that outputs date and time information, a timer that measures the elapsed time from the provision of a measurement start instruction to the provision of a measurement end instruction, a counter that counts the number, and the like.

The storage portion 12 is provided with a storage device using an SRAM (Static Random Access Memory), a flash memory, a hard disk or the like. The storage portion 12 stores various programs to be executed by the control portion 11, data necessary for the execution of the programs, and the like. The programs stored in the storage portion 12 include, for example, a PU classification program that classifies each of the instances included in the inputted set of instances to be classified, as the positive instance or the negative instance.

The programs stored in the storage portion 12 may be provided by a recording medium M where the programs are recorded so as to be readable. The recording medium M is, for example, a portable memory such as an SD (Secure Digital) card, a micro SD card or a compact flash (trademark). In this case, the control portion 11 is capable of reading a program from the recording medium M by using a non-illustrated reading device and installing the read program into the storage portion 12. Moreover, the programs stored in the storage portion 12 may be provided by communication through the communication portion 14. In this case, the control portion 11 is capable of obtaining a program through the communication portion 14 and installing the obtained program into the storage portion 12.

The input portion 13 is provided with an input interface for inputting various data into the device. To the input portion 13, a sensor or an output device that outputs, for example, instances for learning and instances to be classified is connected. The control portion 11 is capable of obtaining the instances for learning and the instances to be classified through the input portion 13.

The communication portion 14 is provided with a communication interface for connection to a communication network (not shown) such as the Internet, and transmits various kinds of information to be notified to the outside and receives various kinds of information transmitted from the outside. While the present embodiment adopts a structure in which instances for learning and instances to be classified are obtained through the input portion 13, a structure may be adopted in which instances for learning and instances to be classified are obtained through the communication portion 14.

The operation portion 15 is provided with a user interface such as a keyboard or a touch panel, and accepts various kinds of operation information and setting information. The control portion 11 performs appropriate control based on the operation information inputted from the operation portion 15, and stores the setting information into the storage portion 12 as required.

The display portion 16 is provided with a display device such as a liquid crystal display panel or an organic EL (Electro Luminescence) display panel, and displays information to be notified to the user based on a control signal outputted from the control portion 11.

While the present embodiment will describe a structure in which the classification method of the present application is implemented by the software processing executed by the control portion 11, a structure may be adopted in which hardware such as an LSI (Large Scale Integration), an ASIC (Application Specific Integrated Circuit) or an FPGA (Field-Programmable Gate Array) that implements the classification method is mounted separately from the control portion 11. In this case, the control portion 11 passes the instances to be classified and the like obtained through the input portion 13 to the above-mentioned hardware to thereby classify each of the instance included in the set of the instances to be classified, as the positive instance or the negative instance in the hardware.

While the present embodiment describes the classification device 1 as one device for the sake of simplicity, the classification device 1 may be formed of more than one processing device or arithmetic device or may be formed of one or more than one virtual machine.

While the present embodiment adopts a structure in which the classification device 1 is provided with the operation portion 15 or the display portion 16, the operation portion 15 and the display portion 16 are not essential, and a structure may be adopted in which an operation is accepted through a computer connected to the outside and information to be notified is outputted to the external computer.

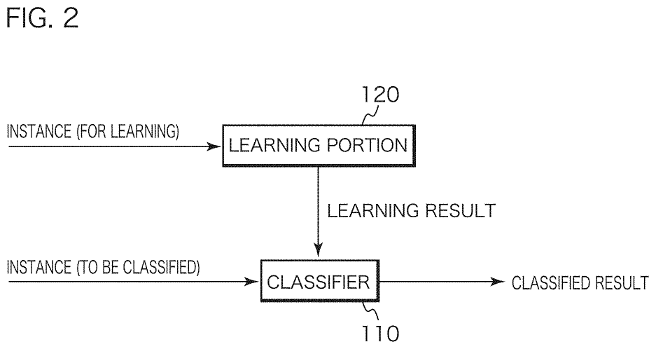

FIG. 2 is an explanatory view explaining the functional components of the classification device 1 according to the first embodiment. The control portion 11 of the classification device 1 executes the control program stored in the ROM and the PU classification program stored in the storage portion 12 to control the operations of the above-described hardware portions, thereby implementing the functions described below.

The classification device 1 is provided with a classifier 110 and a learning portion 120 as functional components. The classifier 110 is a classifier that, when the instance to be classified is given, classifies the given instance to be classified, as the positive instance or the negative instance. While the classification method will be described later in detail, the classifier 110 is a classifier characterized in that maximum likelihood classification of the instance as the positive instance or the negative instance is performed by using a determination inequality to determine the magnitude relationship between the probability (first probability) that the given instance is extracted as a positive instance from the population distribution for learning and the probability (second probability) that the instance is sampled from the population distribution for learning.

The learning portion 120 learns the classifier 110 by using a set of positive instances for learning known as being positive instances and a set of unknown instances for learning not known as being positive or being negative. Specifically, the learning portion 120 learns the classifier 110 by estimating the distribution function of the first probability from a set of positive instances sampled from the population distribution for learning (set of positive instances for learning) and estimating the distribution function of the second probability from a set of instances not known as being positive or being negative which instances are sampled from the population distribution for learning (set of unknown instances for learning).

In the following, an example of application to a detection system that detects a molecule to be detected, by using a nanogap sensor will be described as one example of application of the classification device 1. In this example of application, the classification device 1 is used for classifying signal pulses from the nanogap sensor into signal pulses arising from the molecule to be detected and the other signal pulses containing noise.

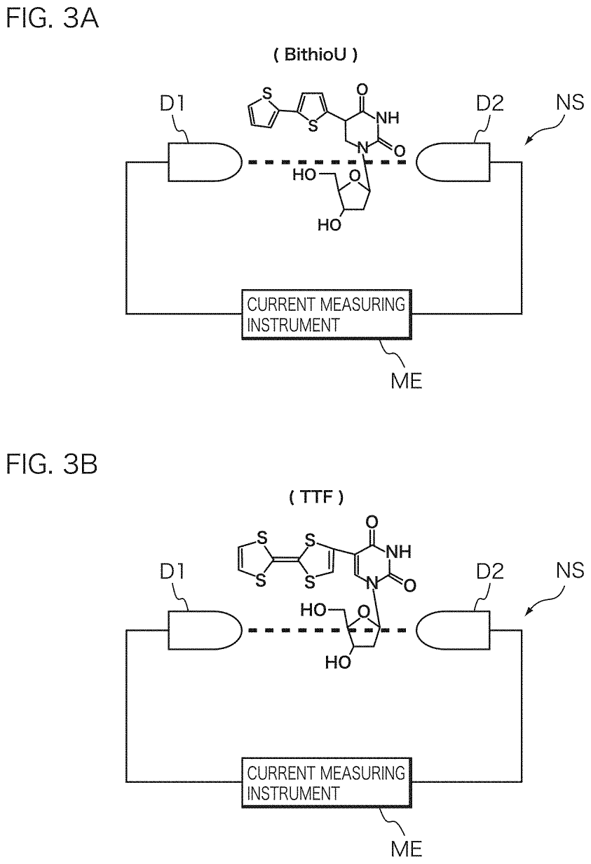

FIGS. 3A and 3B are explanatory views explaining the schematic structure of a measurement system in the detection system. The detection system is provided with a nanogap sensor NS. The nanogap sensor NS is provided with a pair of electrodes D1 and D2 disposed with a minute distance (for example, 1 nm) in between and a current measuring instrument ME that measures the current flowing between the electrodes D1 and D2. The electrodes D1 and D2 are, for example, microshape electrodes formed of gold atoms. When a molecule to be detected passes the neighborhood of the gap with a constant voltage being applied to the electrodes D1 and D2, a minute tunnel current flows between the electrodes D1 and D2. The current measuring instrument ME measures, on a time-series basis, the tunnel current flowing between the electrodes D1 and D2 at appropriate time intervals, and outputs the measurement result (pulse signal).

The molecule to be detected is, for example, a dithiophene uracil derivative (BithioU) and a TTF uracil derivative (TTF). These molecules are artificial nucleobases in which the epigenetic part is chemically modified for ease of identification. In the following description, the dithiophene uracil derivative and the TTF uracil derivative as molecules to be detected will also be referred to merely as target bases.

The target base moves in the solution containing it by means such as Brownian motion of the molecule itself, or electrophoresis, electroosmotic flow or dielectrophoresis. The detection system identifies the target molecules in units of one molecule by identifying the pulse waveform when the target base passes the neighborhood of the electrodes D1 and D2 of the nanogap sensor NS. FIG. 3A shows the dithiophene uracil derivative passing the neighborhood of the electrodes D1 and D2, and FIG. 3B shows the TTF uracil derivative passing the neighborhood of the electrodes D1 and D2. The use of this detection system enables, for example, the identification of the kind of the DNA base molecule in units of one molecule, which realizes the identification of the amino acid sequence of peptide and the modified amino molecule serving as a disease marker which identification is difficult with the existing technologies.

However, there are cases where the measurement signal obtained by the measurement system contains a noise pulse due to the influence of the quantum noise of the tunnel current, the thermal motion of the surface atoms constituting the electrodes D1 and D2, the foreign substances contained in the solution and the like. Unless the noise pulse can be appropriately removed, there is a possibility that the noise pulse is misidentified as a pulse derived from the target base, which causes a reduction in identification accuracy.

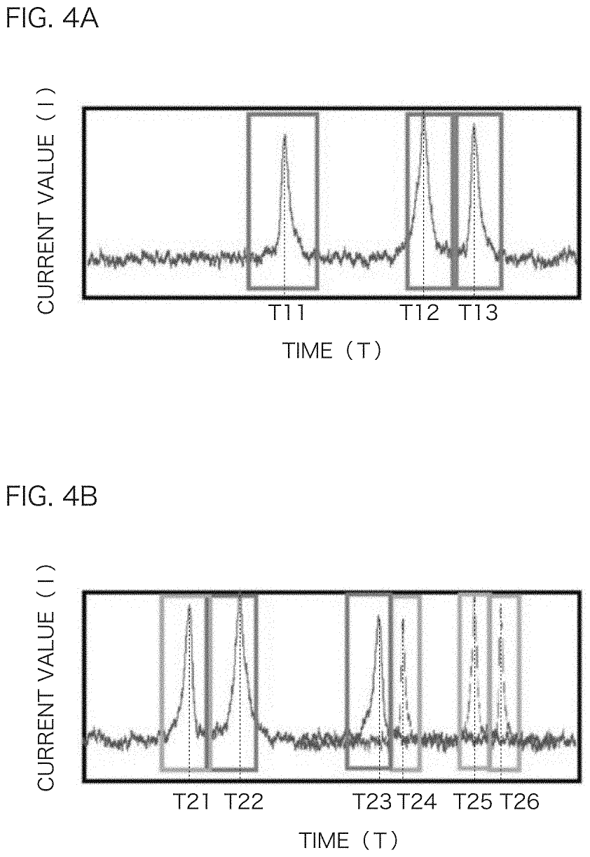

FIGS. 4A and 4B are waveform charts showing an example of the measurement signal obtained by the measurement system. FIG. 4A shows a measurement result under a condition where the target base is not contained, and FIG. 4B shows a measurement result under a condition where the target base is contained. In both waveform charts, the horizontal axis represents the time, and the vertical axis represents the current value.

The measurement signal (instance) obtained by the measurement system generally contains noise. Even when the target base is not contained in the solution to be measured, there are cases where a noise pulse having a certain degree of wave height appears due to the influence of the quantum noise of the tunnel current, the thermal motion of the surface atoms constituting the electrodes D1 and D2, the foreign substances contained in the solution and the like. The example shown in FIG. 4A shows a condition where noise pulses are observed at the times T=T11, T12 and T13. The timing when a noise pulse appears is completely random, and it is impossible to predict the timing of appearance.

On the other hand, when the target base is contained in the solution to be measured, a pulse having a certain degree of wave height is observed due to the tunnel current that flows when the target base passes the neighborhood of the electrodes D1 and D2 of the nanogap sensor NS. This pulse is a pulse derived from the target base (hereinafter, referred to also as target base pulse), and is a pulse to be observed in order to identify the target base. Moreover, even when the target base is contained in the solution to be measured, it is impossible to avoid the noise pulse due to the quantum noise of the tunnel current, the thermal motion of the surface atoms constituting the electrodes D1 and D2, the foreign substances contained in the solution and the like. The example shown in FIG. 4B shows a condition where target base pulses are observed at times T=T21, T24, T25 and T26 and noise pulses are observed at T=T22 and T23.

As mentioned previously, the timing when a noise pulse appears is completely random and it is impossible to predict the timing of appearance. Moreover, as shown in FIG. 4B, the noise pulses have wave heights similar to or not less than the wave heights of the target base pulses. Therefore, in principle, it is impossible to extract only the target base pulse by using only the measurement signal obtained by measuring the target base.

In order to separate and extract the target base pulse contained in the measurement signal from the noise pulse, it is essential to construct the classification method of classifying the target base pulse and the noise pulse. The inventors proposed in Japanese Patent Application No. 2017-092075 a method in which a classifier is constructed that classifies noise pulses (positive instances) and target base pulses (negative instances) based on the measurement signal obtained by the nanogap sensor NS by using a PU classification method based on the Bayesian estimation principle and noise is reduced from the measurement signal.

The existing PU classification method based on the Bayesian estimation principle is based on the assumption that instances for learning used for learning the classifier and instances to be classified not known as being positive or being negative are extracted from the same population distribution, and can perform classification accurately only when these instances are extracted from the same population distribution.

However, when the measurement signal is to be classified, the ratio between the contained noise pulses (positive instances) and target base pulses (negative instances) is not always the same between the measurement signal used for the learning of the classifier and the measurement signal to be actually classified, and these frequently show instances extracted from different population distributions. For this reason, when the measurement signal is classified into positive instances and negative instances by using the existing PU classification method based on the Bayesian estimation principle, sufficient classification accuracy cannot be achieved.

Accordingly, the present application proposes a PU classification method of highly accurately classifying instances to be classified having any positive-to-negative ratio probability distribution as positive instances or negative instances, from a set of positive instances for learning which is a set of positive instances given for learning and a set of unknown instances for learning which is a set of instances where positive instances and negative instances coexist and the ratio between the positive instances and the negative instances is unknown, by a maximum likelihood estimation principle not dependent on the probability distribution followed by the unknown instance set.

Hereinafter, the PU classification method according to the present embodiment will be described.

A set of labeled positive instances given for learning will be referred to as D_{LP}, a set of unlabeled instances given for learning, as D_{LU}, and a set of unlabeled instances for test obtained every measurement, as D_{TU}. The instances of D_{LP} are IID-sampled from a positive instance marginal distribution p_{LP} (X|Y=P), and the instances of D_{LU} and D_{TU} are IID-sampled from marginal distributions p_{LU}(X) and p_{TU}(X), respectively.

Here, X represents the feature vector. The feature vector is a vector containing, as a component, a feature amount reflecting the pulse waveform of each pulse obtained from the measurement signal. As the feature vector, for example, a 10-dimensional feature vector may be used that has, as a component, the average value of the measured current values in the ten sections into which the period from the pulse start time point to the end time point is divided. Not only the average value of the measured current values, a feature vector may be used that contains, as a component, a feature amount such as a wave height value where the pulse peak value is standardized to 1, a wave height value where it is not standardized, a wavelength direction time where the pulse wavelength time is standardized to 1, a wavelength direction time where it is not standardized or a value which is a combination of these. Y represents the positive or negative instance label. In the present embodiment, the noise pulse is the positive instance, and the target base pulse is the negative instance.

In the present embodiment, it is assumed that p_{LP}(X|Y=P), p_{LU}(X) and p_{TU}(X) are formed of the same invariable distribution p(X|Y) (hereinafter, referred to as first assumption). This first assumption is not a special one but a common p(X|Y) is assumed in all the instance sets in all the past PU classification methods. Moreover, it is understood that the first assumption is not a special one also from the fact that various measurement systems including the above-described nanogap sensor NS are designed to stably realize the invariable p(X|Y) in order that robust estimation of Y can be performed with respect to changes of the prior probability density function p(Y).

Since p_{LP}(X|Y=P)=p(X|Y=P) holds from the first assumption, p_{LU}(X) and p_{TU}(X) can be expressed as follows by using the common p(X|Y) with respect to Y=P, N and class prior probabilities π_{L}=p_{LU}(Y=P) and π_{T}=p_{TU}(Y=P) of the positive and negative instances:

p_{LU}(X)=π_{LP}(X|Y=P)+(1−π_{L})p(X|Y=N) (1)

p_{TU}(X)=π_{TP}(X|Y=P)+(1−π_{T})p(X|Y=N) (2)

Here, it is assumed that π_{L} and π_{T}∈[0, 1] are independently given although the values thereof unknown. In order to construct a classifier not requiring the estimation of π_{L} and π_{T}, the present embodiment adopts a classification criterion using a maximum likelihood estimation principle not affected by the class prior probability.

By the first assumption, the maximum likelihood Y of the unlabeled test instance x(∈D_{TU}) is given by the following expression:

$$\begin{matrix}[ Expression 1 ] & \\ y = \{ \begin{matrix}P \text{:} if p ( x \text{\textbar} Y = P ) \geq p ( x \text{\textbar} Y = N ) \\ N \text{:} if p ( x \text{\textbar} Y = P ) < p ( x \text{\textbar} Y = N )\end{matrix} & ( 3 )\end{matrix}$$

Here, for any π∈[0, 1], with respect to p_{π}(X)=πp(X|Y=P)+(1−n)p(X|Y=N), the following two inequalities are equivalent.

p(X|Y=P)≥p_{π}(x) (4)

p(Y|Y=P)≥p(x|Y=N) (5)

Based on the first assumption and the expressions (1) to (5), the following determination inequality given under any π_{L}∈[0,1] is obtained. This determination inequality provides the maximum likelihood classification criterion of the instance x∈D_{TU} conforming to p_{TU}(X) having any n_{T}∈[0, 1] given independently of π_{L}.

$$\begin{matrix}[ Expression 2 ] & \\ y = \{ \begin{matrix}P \text{:} if p ( x \text{\textbar} Y = P ) \geq {p}_{LU} ( x ) \\ N \text{:} if p ( x \text{\textbar} Y = P ) < {p}_{LU} ( x )\end{matrix} & ( 6 )\end{matrix}$$

By using this maximum-likelihood classification criterion, the classifier 110 can be constructed that non-parametrically estimates the estimate value of p(x|Y=P) and the estimate value of p_{LU}(x) from D_{LP} and D_{LU} and performs maximum-likelihood estimation of the label y of x∈D_{TU} by using the above determination inequality.

While the case of p(x|Y=P)=p_{LU}(x) is the positive instance according to the above-described maximum likelihood classification criterion, it is needless to say that a maximum likelihood classification criterion that determines the case of p(x|Y=P)=p_{LU}(x) as the negative instance may be used.

Hereinafter, the operation of the classification device 1 will be described.

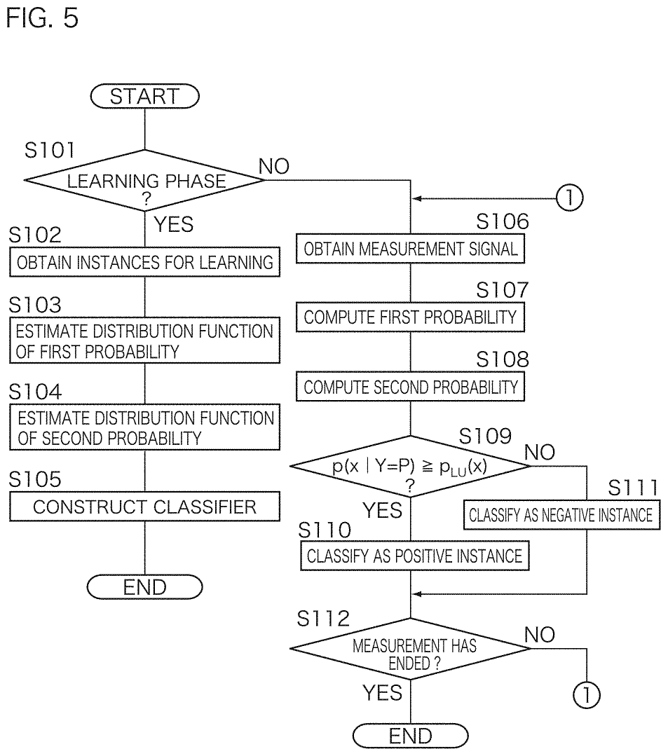

FIG. 5 is a flowchart explaining the procedure of the processing executed by the classification device 1. The control portion 11 of the classification device 1 determines whether the present time is a learning phase or not (step S101). For example, when an instruction to make a shift to the learning phase is accepted in advance through the operation portion 15, the control portion 11 can determine that the present time is the learning phase.

When determining that the present time is the learning phase (S101: YES), the control portion 11 obtains instances for learning through the input portion 13 (step S102). The instances obtained at step S102 are instances sampled from the population distribution for learning. At this time, the control portion 11 measures a solution not containing the target base with the measurement system, and obtains a plurality of measurement signals containing only noise pulses, as instances for learning known as being positive instances. Moreover, the control portion 11 measures a solution containing the target base with the measurement system, and obtains a plurality of measurement signals containing both noise pulses and target base pulses as instances for learning not known as being positive or being negative.

Then, based on a set of positive instances for learning which is a set of instances obtained for learning and known as being positive instances, the control portion 11 estimates the distribution function of the first probability that the instances given as targets of classification are extracted from the population distribution for learning as positive instances (step S103). Specifically, the control portion 11 estimates the function form of p(x|Y=P) of the above-described expression (6) based on the set of positive instances for learning.

Then, based on a set of unknown instances for learning which is a set of instances obtained for learning and not known as being positive or being negative, the control portion 11 estimates the distribution function of the second probability that instances are sampled from the population distribution for learning (step S104). Specifically, the control portion 11 estimates the function form of p_{LU}(x) in the above-described expression (6) based on the set of unknown instances for learning. The order of processing of steps S103 and S104 is arbitrary.

Then, the control portion 11 constructs the classifier 110 having the maximum likelihood classification criterion of the expression (6) by using the distribution function estimated at steps S103 and S104 (step S105). The control portion 11 stores the constructed classifier 110 into the storage portion 12 and ends the learning phase.

When determining that the present time is not the learning phase at step S101 (S101:NO), the control portion 11 determines that it is a classification phase where the inputted instance is classified as a positive instance or a negative instance.

The control portion 11 obtains an instance (measurement signal) to be classified through the input portion 13 (step S106). The instance obtained at step S106 is an instance sampled from the population distribution for classification.

Then, by using the distribution function of the first probability estimated in the learning phase, the control portion 11 computes the estimate value of the first probability that the obtained instance is sampled from the population distribution for learning as a positive instance (step S107).

Then, by using the distribution function of the second probability estimated in the learning phase, the control portion 11 computes the estimate value of the second probability that an instance is sampled from the population distribution for learning (step S108). The order of processing of steps S107 and S108 is arbitrary.

Then, the control portion 11 determines whether the computed first probability p(x|X=P) is higher than or equal to the second probability p_{LU}(x) or not (step S109).

When determining that the first probability p(x|X=P) is higher than or equal to the second probability p_{LU}(x) (S109: YES), the control portion 11 determines that the obtained instance is a positive instance (noise) (step S110), and stores the determination result into the storage portion 12.

Moreover, when determining that the first probability p(x|X=P) is lower than the second probability p_{LU}(x) (S109: NO), the control portion 11 determines that the obtained instance is a negative instance (target base) (step S111), and stores the determination result into the storage portion 12.

While the present embodiment adopts a structure in which the control portion 11 determines that the inputted instance is a positive instance (noise) when the first probability p(x|X=P) is equal to the second probability p_{LU}(x), the control portion 11 may determine that it is a negative instance (target base).

Then, the control portion 11 determines whether the measurement has ended or not (step S112). When determining that the measurement has not ended (S112: NO), the control portion 11 returns the process to step S106. When determining that the measurement has ended (S112: YES), the control portion 11 ends the classification phase.

Hereinafter, the performance evaluation of the classification device 1 according to the first embodiment will be described.

The classification device 1 classifies an inputted instance (measurement signal) to be classified, as a positive instance or a negative instance, and cannot know which pulse in the set of instances containing the target base pulse and the noise pulse is truly a target base pulse, so that the result of classification as a positive or a negative instance cannot be used as the performance index. Accordingly, the value of the pseudo F-measure (F tilde) defined by the following is computed with respect to the test instance set and is used as the performance index.

$$\begin{matrix}[ Expression 3 ] & \\ \tilde{F} = \frac{2 π \vert {\hat{D}}_{TP} \vert / \vert {D}_{TP} \vert}{\vert {\hat{D}}_{TU}^{P} \vert / \vert {D}_{TU} \vert + \tilde{π}} & ( 7 )\end{matrix}$$

Here, D_{TP} is a set of positive instances for test, and D_{TU} is a set of unlabeled instances for test. Moreover, D_{TP} with a hat is a set of instances estimated to be positive instances in the set of positive instances for test, and D^{P}_{TU} with a hat is a set of instances estimated to be positive instance in the set of unlabeled instances for test.

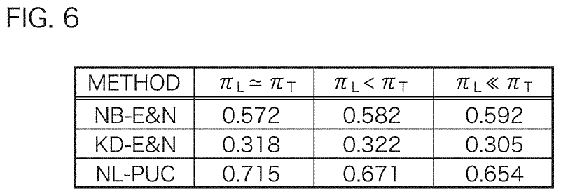

FIG. 6 is a table showing the performance evaluation of the classification device 1 according to the first embodiment. For each instance set, |D_{LP}|=20 and |D_{LU}|=800 are obtained for learning, and |D_{TP}|=20 and |D_{TU}|=100 are obtained for test. Moreover, as objects for comparison, the table also shows the results of calculation of the estimate values of p_{LP}(X|Y=P) and p_{LU}(X) by using two kinds of methods, the Gaussian naive Bayesian estimation (NE-E&N) and the Bayesian estimation using the Gaussian kernel density (KD-E&N) with the use of the PU classifier of Elkan et al. (see Non-Patent Document 1).

The values of the pseudo F-measures of the PU classification methods are shown in FIG. 6. As D_{TU}, the following three were examined: the early stage of the measurement (π_{L}≈π_{T}); when foreign substances are increased after the elapse of some times (π_{L}<π_{T}); and when foreign substances are extremely increased (π_{L}<<π_{T}). Although the values of the pseudo F-measures are different from normal ones and are not standardized to [0, 1], it is indicated that the higher these values are, the higher the classification performance is.

As shown in FIG. 6, it was found that the classification device 1 (NL-PUC: Native Likelihood PUC) according to the first embodiment shows much higher performance than the existing methods irrespective of the value of π_{T}.

As described above, according to the present embodiment, even when the ratio between the contained noise pulses (positive instances) and target base pulses (negative instances) is different between the instances used for learning the classifier and the instances to be actually classified, the inputted instance can be accurately classified as a positive instance or a negative instance.

### Second Embodiment

While the first embodiment adopts a structure in which the distribution function of the first probability is estimated by using a set of positive instances for learning known as being positive instances and the distribution function of the second probability is estimated by using a set of unknown instances for learning not known as being positive or being negative, there are also cases where the instances for learning known as being positive instances cannot sufficiently be obtained. When the instances for learning known as being positive instances cannot sufficiently be obtained, the error of the estimated distribution function of the first probability is large, so that the classification accuracy can decrease.

Accordingly, in the second embodiment, a method will be described by which the distribution function of the first probability can be accurately estimated even when instances for learning known as being positive instances cannot sufficiently be prepared at the time of learning.

In the present embodiment, the reduction in estimation accuracy is suppressed with respect to the distribution function of the first probability not by using only instances known as being positive instances but by also using instances not known as being positive or being negative which instances can generally be prepared in a sufficient number.

It is targeted to obtain a more accurate estimate value of p^{(k)}(X|Y=P) by repetitively updating the estimate value of p_{LP}(X|Y=P) by using the random variable of p^{(k-1)}(X|Y=P) derived from the unlabeled instance set D_{LU} given for learning. The estimate value of p^{(k)}(X|Y=P) can be described as follows:

[Expression 4]

\hat{p}^{(k)}(X|Y=P):=(1−r)\hat{p}_{LP}(X|Y=P)+r\tilde{p}^{(k-1)}(X|Y=P) (8)

Here, r∈[0, 1], and k is an integer not less than 2.

The kernel density p_{K}(X|x) and its weight w(x) gives a nonparametric approximation of p(X|Y=P) shown below.

$$\begin{matrix}[ Expression 5 ] & \\ {\tilde{p}}^{( 1 )} ( X \text{\textbar} Y = P ) = {\sum }_{x ∈ {D}_{LU}} \tilde{w} ( x ) {p}_{K} ( X \text{\textbar} x ) \\ s . t . \tilde{w} ( x ) = \frac{{\hat{p}}_{LP} ( x \text{\textbar} Y = P ) / {\hat{p}}_{LU} ( x )}{{\sum }_{x ∈ {D}_{LU}} {\hat{p}}_{LP} ( x \text{\textbar} Y = P ) / {\hat{p}}_{LU} ( x )} & ( 9 )\end{matrix}$$

In order that the statistical error decreases, the random variable p^{(k-1)}(X|Y=P) is repetitively computed by using the estimate value of p^{(k-1)}(x|Y=P).

$$\begin{matrix}[ Expression 6 ] & \\ {\tilde{p}}^{( k - 1 )} ( X \text{\textbar} Y = P ) = {\sum }_{x ∈ {D}_{LU}} {\tilde{w}}^{( k - 1 )} ( x ) {p}_{K} ( X \text{\textbar} x ) \\ {\tilde{w}}^{( k - 1 )} ( x ) = \frac{{\hat{p}}^{( k - 1 )} ( x \text{\textbar} Y = P ) / {\hat{p}}_{LU} ( x )}{{\sum }_{x ∈ {D}_{LU}} {\hat{p}}^{( k - 1 )} ( x \text{\textbar} Y = P ) / {\hat{p}}_{LU} ( x )} & ( 10 )\end{matrix}$$

When the random variable of w^{(k-1)}(x) sufficiently converges for all the x belonging to the unlabeled instance set D_{LU}, a more accurate estimate value of p^{(k)}(X|Y=P) is obtained.

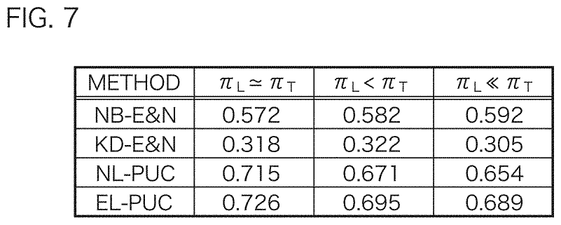

FIG. 7 is a table showing the performance evaluation of the classification device 1 according to the second embodiment. For each instance set, |D_{LP}|=20 and |D_{LU}|=800 are obtained for learning, and |D_{TP}|=20 and |D_{TU}|=100 are obtained for test. As objects for comparison, the table also shows the performance evaluation of the PU classifier of Elkan et al. using two kinds of methods, the Gaussian naive Bayesian estimation (NE-E&N) and the Bayesian estimation using the Gaussian kernel density (KD-E&N) and the performance evaluation of the classifier (NL-PUC) described in the first embodiment.

The value of the pseudo F-measure of each PU classification method is shown in FIG. 7. As D_{TU}, the following three were examined: the early stage of the measurement (π_{L}≈π_{T}); when foreign substances are increased after the elapse of some times (π_{L}<π_{T}); and when foreign substances are extremely increased (π_{L}<<π_{T}). Although the values of the pseudo F-measures are different from normal ones and are not standardized to [0, 1], it is indicated that the higher these values are, the higher the classification performance is.

As shown in FIG. 7, it was found that the classification device 1 (EL-PUC: Enhanced Likelihood PUC) according to the second embodiment shows higher performance than the existing methods and the classification device 1 (NL-PUC) according to the first embodiment although the number of positive instances for learning is small.

As described above, according to the present embodiment, even when the number of instances of the positive instance set obtained for learning is small, the estimation accuracy can be improved, so that the measurement signal can be accurately classified as a positive instance or a negative instance.

It should be considered that the embodiments disclosed this time are illustrative in all aspects and is not limitative. The scope of the present invention is indicated not by the meaning described above but by the claims, and all changes that fall within the meaning equivalent to the claims and the scope are to be embraced.

For example, while the present embodiment describes, as an example, a structure in which the classifier 110 is learned by using instances containing only noise pulses and instances containing both target base pulses and noise pulses and instances containing both target base pulses and noise pulses inputted as objects to be classified are classified as positive instances (noise pulses) and negative instances (target base pulses), the instances to be classified are not limited measurement signals (instances) measured by a specific sensor but may be arbitrary instances.

It is noted that, as used herein and in the appended claims, the singular forms “a”, “an”, and “the” include plural referents unless the context clearly dictates otherwise.

1-6. (canceled)

7. A PU classification device comprising:
a classifier that performs maximum likelihood classification of an instance to be classified as a positive instance or a negative instance based on a magnitude relationship between a first probability that the instance is sampled from a population distribution for learning as the positive instance and a second probability that the instance is sampled from the population distribution for learning, when the instance to be classified is given; and
a processor that learns the classifier by estimating a distribution function of the first probability from a set of positive instances sampled from the population distribution for learning and by estimating a distribution function of the second probability from a set of instances that are sampled from the population distribution for learning and are unknown whether they are positive or negative,
wherein an instance to be classified is classified as the positive instance or the negative instance by using the classifier learned by the processor.

8. The PU classification device according to claim 7,
wherein the processor estimates the distribution function of the first probability based on both the set of positive instances sampled from the population distribution for learning and the set of instances that are sampled from the population distribution for learning and are unknown whether they are positive or negative.

9. The PU classification device according to claim 8,
wherein the processor estimates the distribution function of the first probability by kernel density estimation using a kernel density and a weight to the kernel density.

10. The PU classification device according claim 7,
wherein the classifier classifies the instance to be classified, as the positive instance when determining that the first probability is higher than the second probability, and classifies the instance to be classified, as the negative instance when determining that the first probability is lower than the second probability.

11. A PU classification method comprising:
learning a classifier that performs maximum likelihood classification of an instance to be classified as a positive instance or a negative instance based on a magnitude relationship between a first probability that the instance is sampled from a population distribution for learning as the positive instance and a second probability that the instance is sampled from the population distribution for learning, when the instance to be classified is given, by estimating a distribution function of the first probability from a set of positive instances sampled from the population distribution for learning and by estimating a distribution function of the second probability from a set of instances that are sampled from the population distribution for learning and are unknown whether they are positive or negative; and
classifying an instance to be classified as the positive instance or the negative instance by using the learned classifier.

12. A non-transitory computer readable recording medium storing a PU classification program, the PU classification program comprising:
causing a computer to learn a classifier that performs maximum likelihood classification of an instance to be classified as a positive instance or a negative instance based on a magnitude relationship between a first probability that the instance is sampled from a population distribution for learning as the positive instance and a second probability that the instance is sampled from the population distribution for learning, when the instance to be classified is given, by estimating a distribution function of the first probability from a set of positive instances sampled from the population distribution for learning and by estimating a distribution function of the second probability from a set of instances that are sampled from the population distribution for learning and are unknown whether they are positive or negative; and
causing the computer to classify an instance to be classified as the positive instance or the negative instance by using the learned classifier.
